(19) United States
(12) Patent Application Publication
(10) Pub. No.: US 2012/0182330 A1
(43) Pub. Date: Jul. 19, 2012

(54) DISPLAY APPARATUS AND DRIVING METHOD OF DISPLAY APPARATUS

(76) Inventor: Kazutaka NAGAOKA, Kumagaya-shi (JP)

(21) Appl. No.: 13/432,455

(22) Filed: Mar. 28, 2012

Related U.S. Application Data
(63) Continuation of application No. PCT/JP10/68199, filed on Oct. 15, 2010.

(30) Foreign Application Priority Data
Oct. 16, 2009 (JP) 2009-239581

(51) Int. Cl. G09G 5/10

(52) U.S. Cl. 345/690; 345/204

(57) ABSTRACT

According to one embodiment, a display apparatus includes a display region including a plurality of display pixels arranged in a matrix, a plurality of scanning lines arranged along rows in which the plurality of display pixels are arranged, a plurality of signal lines arranged along columns in which the plurality of display pixels are arranged, a driver including a scanning line driver configured to drive the plurality of scanning lines and a signal line driver configured to drive the plurality of signal lines, and a controller configured to control operation of the driver. The signal line driver includes a memory configured to store at least two frames of video signal data supplied from an external signal source.

### CROSS REFERENCE TO RELATED APPLICATIONS

This application is a Continuation Application of PCT Application No. PCT/JP2010/068199, filed Oct. 15, 2010 and based upon and claiming the benefit of priority from prior Japanese Patent Application No. 2009-239581, filed Oct. 16, 2009, the entire contents of which are incorporated herein by reference.

### FIELD

Embodiments described herein relate generally to a display apparatus and a driving method of the display apparatus.

### BACKGROUND

Usual display device comprises, for example, a display region including a plurality of display pixels arranged in a matrix, a plurality of scanning lines arranged along rows of the plurality of display pixels, a plurality of signal lines arranged along the columns of the plurality of display pixels, a scanning line driving circuit which is connected to the plurality of scanning lines, a signal line driving circuit which is connected to the plurality of signal lines, and a controller which controls the scanning line driving circuit and the signal line driving circuit.

A video signal and a clock signal are supplied to the controller from an external signal source. The controller supplies a horizontal synchronization signal to the scanning line driving circuit, and supplies a vertical synchronization signal and the video signal to the signal line driving circuit, based on the video signal and the clock signal supplied from the external signal source.

The scanning line driving circuit and the signal line driving circuit drive the plurality of scanning lines and the plurality of signal lines, and write the video signal to the display pixels, based on the horizontal synchronization signal and the vertical synchronization signal supplied from the controller.

As stated above, a signal to be written to each of the plurality of display pixels are supplied from the external signal source, and updated for each frame period. With this display device, even for the case where a predetermined still picture is displayed on the display region, for example, a video signal is supplied to the controller from the external signal source. For example, it is suggested that a liquid crystal display device comprises a frame memory in which a driving circuit stores image data for a frame, a digital-to-analog converter which converts digital data from the frame memory to an analog signal, a buffer circuit, and a control circuit which controls operations of the frame memory, the digital-to-analog converter, and so forth. In the liquid crystal display device, the frame memory, the digital-to-analog converter, the buffer circuit and the control circuit are implemented by a single IC chip.

With the display device which comprises the driving circuit having the frame memory which stores image data for one frame, when broadcast content based on a broadcast signal is displayed bordered by the frame image, for example, the frame image stored in the frame memory is superimposed on the broadcast content based on the broadcast signal, the superimposed image is temporarily stored in an external memory, and the image stored in the external memory is sequentially read and displayed.

In addition, to display a three-dimensional (3D) image by alternately displaying the images for right-eye and left-eye, it is necessary to continuously supply video signals to the control circuit from the external signal source even for a still picture, and it is necessary to rewrite data stored in the frame memory. For such display devices, it is difficult to reduce power consumption of the external signal source.

### BRIEF DESCRIPTION OF THE DRAWINGS

FIG. 1 illustrates an example of configuration of a display apparatus according to an embodiment.

FIG. 2 illustrates an example of configuration of the signal line driving circuit of the display apparatus according to the first embodiment.

FIG. 3 illustrates an example of operation of the display apparatus according to the first embodiment.

FIG. 4 illustrates an example of configuration of the signal line driving circuit of the display apparatus according to the second embodiment.

FIG. 5 illustrates another example of configuration of the signal line driving circuit of the display apparatus according to the first embodiment.

### DETAILED DESCRIPTION

In general, according to one embodiment, a display apparatus comprises a display region including a plurality of display pixels arranged in a matrix, a plurality of scanning lines arranged along rows in which the plurality of display pixels are arranged, a plurality of signal lines arranged along columns in which the plurality of display pixels are arranged, a driver including a scanning line driver configured to drive the plurality of scanning lines and a signal line driver configured to drive the plurality of signal lines; and a controller configured to control operation of the driver. The signal line driver comprises a memory configured to store at least two frames of video signal data supplied from an external signal source.

In the following, the display apparatus according to the first embodiment will be described in detail with reference to the drawings. The display apparatus according to this embodiment is a light-transmission-type liquid crystal display apparatus comprising an array substrate 110, a countersubstrate 120 arranged to be opposed to the array substrate 110, a liquid crystal layer LQ provided and supported between the array substrate 110 and the countersubstrate 120, and a display region DYP including display pixels PXs arranged in a matrix. The liquid crystal display apparatus comprises a backlight on the back of the apparatus as a light source. The display apparatus may be an organic electroluminescent display apparatus, for example, instead of the liquid crystal display apparatus, and the organic electroluminescent display apparatus can eliminate an backlight.

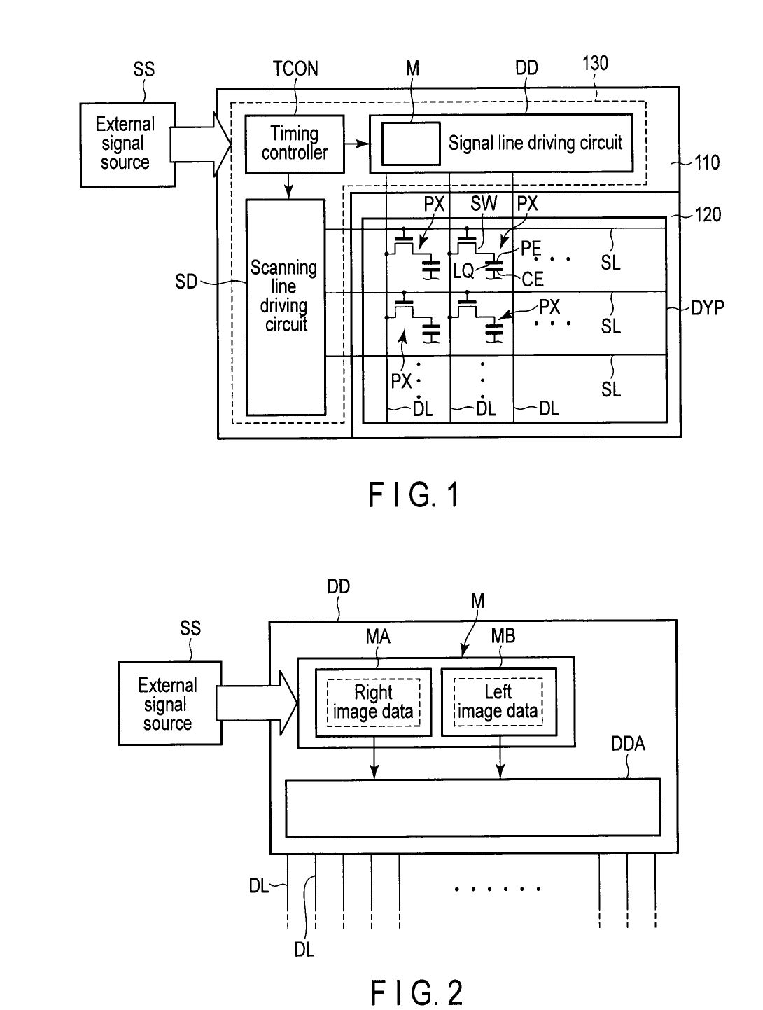

As shown in FIG. 1, the array substrate 110 comprises pixel electrodes PE each placed in a display pixel PX, a plurality of scanning lines SLs extending along the rows of the plurality of display pixels PEs, a plurality of signal lines DLs arranged along the columns of the plurality of display pixels PEs, and a pixel switch SW arranged close to each intersection of the scanning line SL and the signal line DL.

The pixel switch SW is a thin film transistor comprising a polysilicon layer as a semiconductor layer, for example. The gate electrode of the pixel switch SW (not shown in the drawings) is electrically connected to the corresponding scanning line SL (or is integrally formed with the corresponding scanning line SL). The source electrode of the pixel switch SW (not shown in the drawings) is electrically connected to the corresponding signal line DL (or is integrally formed with the corresponding signal line DL). The drain electrode of the pixel switch SW (not shown in the drawings) is electrically connected to the corresponding pixel electrode PE (or is integrally formed with the corresponding pixel electrode PE).

The countersubstrate 120 comprises a counterelectrode CE_arranged to be opposed to the plurality of pixel electrodes PEs. The counterelectrode CE is supplied with a countervoltage from a counterelectrode driving circuit (not shown in the drawings). The plurality of pixel electrodes PEs and the counterelectrode CE are covered with an orientation film (not shown in the drawings). The surface of the orientation film may be rubbed if required.

The array substrate 110 comprises a driver 130 arranged on the peripheral of the display region DYP. The driver 130 is formed of one chip, for example, and is directly bonded to a non-display region of the array substrate 110 by face down bonding. The driver 130 comprises a scanning line driving circuit SD, a signal line driving circuit DD, and a timing controller TCON which controls operations of the scanning line driving circuit SD and the signal line driving circuit DD. The scanning line driving circuit SD is electrically connected to the plurality of scanning lines SL. The signal line driving circuit DD is electrically connected to the plurality of signal lines DL.

The timing controller TCON is supplied with video signal data and a clock signal from an external signal source SS. The timing controller TCON supplies a horizontal synchronization signal to the scanning line driving circuit SD based on the clock signal. The timing controller TCON also supplies a vertical synchronization signal and the video signal data to the signal line driving circuit DD based on the video signal data and the clock signal.

In the display apparatus according to the present embodiment, the signal line driving circuit DD comprises a memory M which stores the video signal data, and a driver DDA which performs digital-to-analog conversion on the video signal data read from the memory M and outputs the resultant analog signal as a predetermined signal voltage. The memory M is, for example, a volatile memory such as a dynamic random access memory (DRAM), and has sufficient size to store at least two frames of video signal data. For example, if the display apparatus is composed of (640×3)×480 8-bit pixels, the memory M should have a capacity of [(640×3)×480]×2×8. In addition, the display apparatus according to the present embodiment comprises a DRAM which is capable of high-speed data reading.

The external signal source SS and the timing controller TCON transmit a signal by using an interface such as Mobile Industry Processor Interface (MIPI), Serial Peripheral Interface (SPI), and Mobile Display Digital Interface (MDDI), for example. The external signal source SS and the memory M of the signal line driving circuit DD may be directly connected to each other via a transmission path such as a memory bus, for example. By using the transmission path such as the memory bus, high-speed data transmission between the external signal source SS and the memory M is realized.

The external signal source SS supplies video signal data, a clock signal, and an address signal to the timing controller TCON or the memory M. The video signal data supplied to a predetermined address of the memory M is written in accordance with the address signal supplied by the external signal source SS.

In addition, the display apparatus according to the present embodiment is capable of displaying a 3D image, and the external signal source SS supplies a switching signal used for switching two-dimensional (2D) image display and 3D image display to the timing controller. The 3D image is produced by parallax between left and right perspectives when a right image which is viewed by the right eye of a user and a left image which is viewed by the left eye of the user are alternately displayed. The outgoing light beams from the backlight have directions for the left eye and right eye, and are switched by synchronizing with the displayed images so as to produce the 3D. The 3D image can be produced by combining a parallax barrier such as a lenticular film with the display apparatus.

As shown in FIG. 2, in the display apparatus according to the present embodiment, the signal line driving circuit DD comprises the memory M and the driver DDA. The memory M comprises first and second storage regions MA and MB each of which is capable of storing one frame of video signal data.

For example, if a signal for switching to 3D image display is supplied from the external signal source SS, right image data (data indicating an image for right eye) for one frame is written in the first storage region MA, and left image data (data indicating an image for left eye) for the next frame is written in the second storage region MB. If a signal for switching to 2D image display is supplied from the external signal source SS, data for image display of each frame is written alternately in the first and second storage regions MA and MB.

As stated above, the external signal source SS and the memory M of the signal line driving circuit DD are directly connected via the transmission path such as a memory bus, and the memory M is rewritten only if the video signal data is updated. That is, the memory M is not rewritten for the still image.

For the case shown in FIG. 2, the video signal data is supplied to the memory M from the external signal source SS; however, the signal line driving circuit DD may be configured so that the video signal data is supplied to the memory M from the timing controller TCON.

In this embodiment, the scanning line driving circuit SD, the signal line driving circuit DD and the timing controller TCON are loaded on one chip; however, a part of the scanning line driving circuit SD, the signal line driving circuit DD or the timing controller TCON may be formed integrally on the array substrate by using the thin film transistor comprising the polysilicon layer as the semiconductor layer in the same process as forming the pixel switch SW, for example. In FIG. 1, the scanning line driving circuit SD, the signal line driving circuit DD and the timing controller TCON are shown separately for explanation.

In the display apparatus, the timing controller TCON supplies a horizontal synchronization signal to the scanning line driving circuit SD based on the clock signal supplied from the external signal source SS. The scanning line driving circuit SD sequentially supplies a gate voltage to the scanning line SL in accordance with the horizontal synchronization signal supplied from the timing controller TCON. If the gate voltage is supplied to the scanning line SL, the conduction between the source and the drain of the pixel switch SW connected to the scanning line SL is realized.

In addition, the timing controller TCON sequentially read the video signal data from the memory M based on the clock signal supplied from the external signal source SS, and supplies the video signal data to the signal line driving circuit DD along with a vertical synchronization signal.

The video signal data supplied to the signal line driving circuit DD is subjected to the digital-to-analog conversion and converted to a grayscale image signal corresponding to the grayscale presented in the display pixel PX, and the grayscale image signal is supplied to the plurality of signal lines DL in accordance with the vertical synchronization signal. The grayscale image signal supplied to the signal line DL is supplied to the pixel electrode PE through the pixel switch SW.

The timing controller TCON controls the scanning line driving circuit SD and the signal line driving circuit DD to supply the corresponding grayscale image signals to all pixel electrodes PE for one frame period.

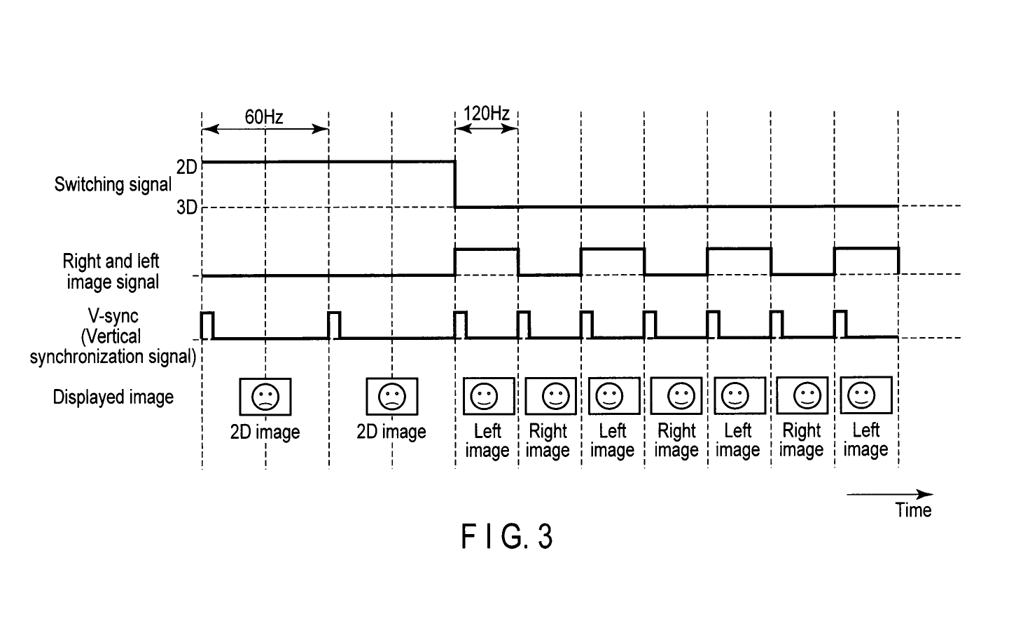

For example, if a switching signal to switch from 2D image display to 3D image display is supplied to the timing controller TCON, the timing controller TCON outputs a vertical synchronization signal having a frequency twice that for 2D image display. FIG. 3 shows the case where the frequency of the vertical synchronization signal for 2D image display is 60 Hz, and the frequency of the vertical synchronization signal for 3D image display is 120 Hz. right image data (data indicating an image for right eye) for one frame is written in the first storage region MA, and left image data (data indicating an image for left eye)

For the case where 3D image is displayed, right image data for one frame is written in the first storage region MA from the external signal source SS, and left image data for one frame is written in the second storage region MB. Namely, the data for right image is written to predetermined addresses of the first storage region MA of the memory M, and the data for left image is written to predetermined addresses of the second storage region MB of the memory M, in accordance with the address signal supplied from the external signal source SS or the timing controller TCON. If the display image is a still picture, the external signal source SS does not update the memory M, and if the display image is a video, the external signal source SS sequentially update the memory M.

The data for right image and the data for left image are alternately read from the first storage region MA and the second storage region MB in accordance with the vertical synchronization signal, and supplied to the driver DDA. The driver DDA converts the data into the corresponding grayscale image signal to be supplied to each of the plurality of signal lines DLs.

As described above, in the present embodiment, since the memory M has a memory capacity for at least two frames, the external signal source SS merely sequentially transmits the video signal data to the display apparatus, and does not need to have a surplus memory even for the case where 3D image is displayed. In addition, for displaying a still image, supplying the video signal data from the external signal source SS to the memory M can be stopped. This reduces power consumption of the external signal source SS.

According to the present embodiment, it is possible to provide a display apparatus and a driving method of the display apparatus capable of reducing the power consumption of the external signal source.

For the cases other than the case for displaying 3D image as stated above, supplying the video signal from the external signal source SS can be stopped while the data stored in the memory M is read, and the grayscale image signal is supplied to the signal line DL from the driver DDA. This can be reduce the power consumption.

For example, if a 2D still image is displayed on the display region DYP, the still image data stored in the memory M is read and supplied to the signal line DL to display the still image on the display region DYP. For this case, supplying the image signal to the memory M from the external signal source SS can be stopped until when the still image is updated, and the power consumption can be reduced.

In the following, the display apparatus according to the second embodiment will be described in detail with reference to the drawings. In the embodiments described below, units specified by the same reference number as in the first embodiment carry out the same operation, and the explanation will be omitted. The display apparatus according to this embodiment is a light-transmission-type liquid crystal display apparatus comprising an array substrate 110, a countersubstrate 120 arranged to be opposed to the array substrate 110, a liquid crystal layer LQ provided and supported between the array substrate 110 and the countersubstrate 120, and a display region DYP including display pixels PX arranged in a matrix.

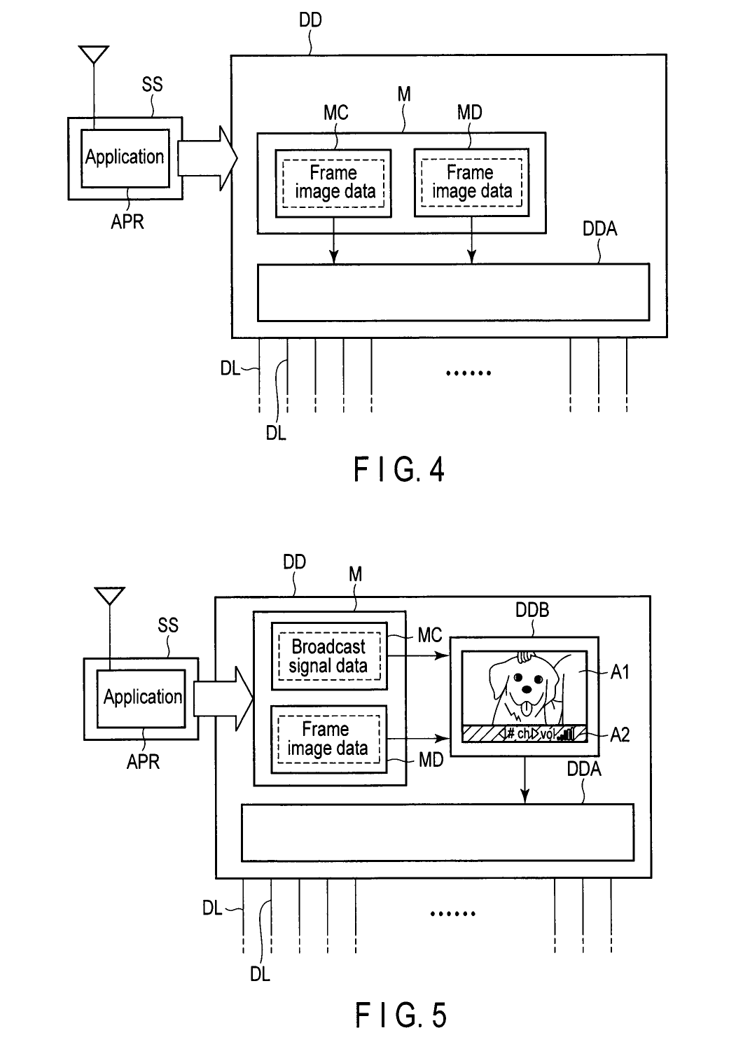

As in the first embodiment, in the display apparatus according to the present embodiment, a signal line driving circuit DD comprises a memory M which stores the video signal data, and a driver DDA which performs digital-to-analog conversion on the video signal data read from the memory M and outputs the resultant analog signal as a predetermined signal voltage, as shown in FIG. 4. The memory M is, for example, a volatile memory such as a DRAM, and has sufficient size to store at least two frames of video signal data.

An external signal source SS comprises an application APR which receives a broadcast signal, for example. The broadcast signal may be a signal provided by one-segment partially receiving service (one-segment) dedicated to a mobile terminal such as a mobile phone which distributes digital terrestrial broadcasting.

In the display apparatus, the broadcast signal received by the application APR is demodulated to a Moving Picture Experts Group 2 (MPEG 2) Transport Stream signal (TS), for example, in the external signal source SS, and the MPEG2-TS signal is divided into an image Packetized Elementary Stream signal (PES) and an audio PES signal.

The PES signal is decoded by a decoder (not shown in the drawings), and supplied to the display apparatus as video signal data. The PES audio signal is decoded by a decoder (not shown in the drawings), and supplied to a speaker (not shown in the drawings) as an audio signal.

For example, in the conventional mobile phone, the video signal data based on the broadcast signal received by the application APR is combined with a frame image obtained from the external signal source SS, temporarily written to an external memory, and sequentially supplied to the display apparatus.

In contrast, in the present embodiment, the frame image supplied from the external signal source SS is stored in each of a third storage region MC and a forth storage region MD of the memory M. The video signal data supplied from the external signal source SS is written to designated addresses of the third storage region MC. The video signal data combined in the third storage region MC is sequentially read, and the image is displayed. In the next frame period, the video signal data supplied from the external signal source SS is written to designated addresses of the forth storage region MD, and the combined video signal data is sequentially read to be displayed.

The frame image is an image (for example, image displayed in region A2 shown in FIG. 5) displayed around a broadcast image (for example, image displayed in region A1 shown in FIG. 5), and the frame image presents for example the setting of the apparatus such as the channel, volume or brightness. The frame image data stored in the third storage region MC and the forth storage region MD of the memory M is not rewritten unless the display status is changed.

With the above structure, it is possible to reduce the amount of signal data from the external signal source SS by alternately using the third and fourth storage regions MC and MD of the memory M, and writing video signal data by designating the address. In addition, for displaying a still image, since the video signal data is not necessary to be rewritten, power consumption can be reduced.

The video signal data stored in the third and fourth storage regions MC and MD is sequentially supplied to the driver DDA. The driver DDA converts the supplied video signal to the corresponding grayscale image signal by digital-to-analog conversion, and supplies the resultant analog signal to each of the plurality of signal lines DL.

As stated above, with the structure that the signal line driving circuit DD comprises the memory M capable of storing at least two frames of video signal data, the display apparatus can directly receive the video signal data, and display an image by combining the frame image data. This reduces the signal processing of the external signal source SS, thereby reducing power consumption.

Further, since the video signal data and the frame image data are not rewritten unless the display status is changed, the amount of transmission data can be reduced, thereby reducing power consumption.

According to the present embodiment, it is possible to provide a display apparatus and a driving method of the display apparatus capable of reducing the power consumption of the external signal source.

The present invention is not limited to the above-mentioned embodiments, and the structural elements can be modified unless the modified elements deviate the subject matter when implemented. The structural elements of the display apparatus may be configured as hardware or software.

In addition, various inventions can be made by combining any structural elements disclosed in the above embodiments. For example, some structural elements can be deleted from all structural elements described in the above embodiments. Further, structural elements described in the different embodiments can be combined.

For example, the display apparatus according to the second embodiment can be configured to comprise: a memory M which includes a third storage region MC which stores video signal data transmitted from an external signal source SS and a forth storage region MD which stores frame image data; and a video signal generation unit DDB which combines the video signal data and the frame image data, as shown in FIG. 5. In this case, although the number of elements of the signal line driving circuit DD increases, the signal processing of the external signal source SS can be reduced as in the above embodiments, and the advantage of reducing the amount of data transmitted from the external signal source SS can be realized.

FIG. 5 shows an example of image combined by the video signal generation unit DDB. In region Al of the combined image, an image based on the broadcast signal data is displayed, and in region A2, an image based on the frame image data is displayed.

There is a case where a mobile phone has a function of changing the aspect ration of screen from 9:16 to 16:9 by rotating the display screen. Even for such a case, according to the present embodiment, the combined image can be displayed by rewriting the frame image data and combining images at the video signal generation unit DDB.

As explained above, according to the present invention, it is possible to provide a display apparatus and a driving method of the display apparatus capable of reducing the power consumption of the external signal source.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display apparatus comprising:
a display region including a plurality of display pixels arranged in a matrix;
a plurality of scanning lines arranged along rows in which the plurality of display pixels are arranged;
a plurality of signal lines arranged along columns in which the plurality of display pixels are arranged;
a driver including a scanning line driver configured to drive the plurality of scanning lines and a signal line driver configured to drive the plurality of signal lines; and
a controller configured to control operation of the driver,
wherein the signal line driver comprises a memory configured to store at least two frames of video signal data supplied from an external signal source.

2. The display apparatus according to claim 1, wherein the memory comprises a RAM storing at least two frames of the video signal data supplied from the external signal source.

3. A driving method for use in a display apparatus comprising:
a driver configured to drive a display region; and
a controller configured to control the driver,
wherein the driver comprises a memory having a first and second storage regions and configured to store at least two frames of data supplied from an external signal source,
the method comprising:
storing image data for right eye in the first storage region if a signal to switch from 2D image display to 3D image display is supplied from the external signal source and to store image data for left eye in the second storage region; and
alternately supplying a grayscale image signal corresponding to data read from the first storage region and a grayscale image signal corresponding to data read from the second storage region to the display region.

4. A driving method for use in a display apparatus comprising:
a driver configured to drive a display region; and
a controller configured to control the driver,
wherein the driver comprises a memory having a third and fourth storage regions and configured to store at least two frames of data supplied from an external signal source, and a video signal generation unit configured to combine data read from the memory and to generate a video signal,
the method comprising:
storing one frame of broadcast signal data supplied from the external signal source in the third storage region;
reading the broadcast signal data stored in the third storage region and image data stored in the fourth storage region, and combining the read data at the video signal generation unit to generate a video signal; and
supplying a grayscale image signal corresponding to the video signal generated at the video signal generation unit to the display region.
